(19) United States
(12) Patent Application Publication
(10) Pub. No.: US 2009/0204495 A1
(43) Pub. Date: Aug. 13, 2009

(54) Method of advertising

(76) Inventor: John Z. Schroeder, Atlanta, GA (US)

Correspondence Address: SHUMAKER LOOP & KENDRICK, 101 E. KENNEDY, SUITE 2800, TAMPA, FL, 33672-0609, US

(21) Appl. No.: 12/315,228

(22) Filed: Dec. 1, 2008

Related U.S. Application Data
(60) Provisional application No. 60/991,710, filed on Dec. 1, 2007.

(51) Int. Cl. G06Q 30/00

(52) U.S. Cl. 705/14; 705/10

(57) ABSTRACT

The present invention comprises a method for advertising a product comprising the selection of an updatable venture comprising updatable parameters; one or more parametric interrelationships which give, upon operating on at least one of said updatable parameters, one or more resultant values; wherein at least one of said parameters is updatable to give one or more updated parameters; wherein upon the operation by said interparameteric relationships on at least one of said updated parameters, one or more updated resultant values are produced; and engaging at least one subscriber to said updatable venture who, upon accessing the resultant values through a user interface, is exposed to advertising specific to the product.

### PRIORITY

This application is a non-provisional of U.S. provisional application Ser. No. 60/991,710, filed on Dec. 1, 2007, which is herein incorporated by reference.

### BACKGROUND

Current methods of advertising products and services that do not yet have high brand or name recognition are often based upon the theory that the recipient of the advertising message will either immediately mentally absorb the information or immediately disregard it. Some have speculated that information which is delivered to a recipient at a time when the recipient is unreceptive will not be acted upon, and if the information is delivered at a time when the recipient is both unreceptive and likely to resent the interruption, such as when a pop-up advertising a painkiller appears while the recipient is checking the latest stock report online, the effect of delivery may be to create a bias against the product in the mind of the recipient, preventing the advertising message from being effective upon reaching the recipient at a time when the recipient would otherwise be at least receptive to the message. By “receptive,” it is meant that the recipient is willing to listen to the advertising message, evaluate the truth and attractiveness of the offer, and seriously consider responding to the message.

However, repeated exposure of a receptive recipient (and possibly even unreceptive recipients) to an advertising message has been thought to increase a recipient's likelihood to view the message as true. Even so, even initially receptive audiences can be turned off by or desensitized to an advertising message by unwanted repeated exposure to the message, making them less likely to act on the message, regardless of whether the recipient thinks the message is true. The art would welcome an advertising method that can reach recipients who are either receptive or who can easily be made to be receptive, with repeated doses of advertising without desensitizing the receptive recipient and without creating a negative bias in the mind of those who are not yet receptive.

### DESCRIPTION OF THE INVENTION

The present inventive method enables an advertiser to market a product by utilizing the powerful compulsion of an intended recipient (“recipient”) to inform themselves on a recurrent basis about new developments with regard to a topic of interest. The method is characterized by delivering the advertising with information the recipient is actively seeking. Furthermore, because the information is sought as part of an updatable venture, the recipient returns to the means of exposure in order to receive updated information. Moreover, the updates received not only inform the recipient in a way that other real time news sources can, it also has the ability to deliver information that other news sources would not necessarily include with their reports. In some embodiments, the recipient can even directly receive information which may be of great personal interest, but is not reported from other real time news sources at all. In even more embodiments, the advertising method of the present invention is flexible such the recipient can interact and personalize the calculations used in deriving the substance of the report. In the foregoing embodiment, the recipient can also receive information actively sought in a manner which transcends mere informing, and can actually learn about the methods available for deriving the sought information, and, in time, can gather enough information to assess the accuracy of his or her methods. All of the foregoing embodiments deliver product information at a time when the recipient is likely to be receptive because he or she is first and foremost receiving something of value. Furthermore, the method instills in the recipient the desire to return and receive updated information, and, simultaneously, repeat exposure to advertising information at times at which the recipient has a high likelihood of being receptive. The received information is often derived from parameters in a personally directed fashion and thus much greater in scope and personal satisfaction than that available from other reporting sources.

The present method can strongly and specifically appeal to people who are motivated to seek a certain type of information, as a result, the advertising can specifically pair a product with the appropriate target demographic. Unlike other methods, the present method re-exposes the target demographic in a repeated and reinforcing manner, to advertising information, at a time when the recipient is likely to be generally receptive to information, while instantly giving the advertising recipient something to dull the intrusion of the advertising message.

The method is generalizable to a wide range of updatable ventures. In general, by “updatable venture” is meant an outcome whose likelihood can be estimated in advance, the likelihood being changeable based upon events which happen before the outcome. With respect to the present inventive method, in some embodiments, the outcome is scheduled to occur at a known date, but this is not an absolute necessity with respect to outcomes as defined by the present invention. In preferred embodiments of the present invention, the events which affect the prediction of the outcome occur on dates known in advance, such as games in a league series. However, in other embodiments, the events can have a much more general meaning: the success of a film, as measured by, for example, critical reviews, can be used to predict the probability of the film's director winning an Oscar.

Examples of updatable ventures relating to many fields of endeavor can be used in the method of the present invention, such as sports, finance, entertainment, and the like. Sports ventures can include, but are in no way limited to, the ranking of teams in a league according to their performance in games against other members of the league; the prediction of game, series or playoff victors or other outcomes such lesser placings, or the league members who will occupy a given playoff slot at a given time in the season, and other predictions, mid season rankings or rankings at other points in the season (such as with respect to the rank that a given team is expected to hold at the end of the season, at a time prior to the end of the season, based upon the team performance to date in terms of victories over other teams) or other outcomes which can be affected or changed by the occurrence of future events.

In other embodiments, the parameters can include individual players rather than teams, the interparametric relations can comprise, for example, methods and formulae for calculating results such as likelihood of winning trophies or awards, and the updated results can comprise recalculations of results based upon performance in the most recent games.

In another embodiment, the method can be used in the context of fantasy sports teams and leagues, based on the performance of real teams and players.

The parameters useful with respect to the foregoing ventures can include game victors, margins of victory, playing field (home or away, for example), games won, games lost, won/lost ratio, number of total games, and the like. Resultant values which can change in response to updating of parameters can include ranking of individual teams, overall ranking, and the like.

In some embodiments, interparameteric relationships can be standard, such as one of the commonly used ranking methods which calculate a given team's ranking with respect to the remaining teams in its league based upon input parameters such as opponents, margins of victory over each opponent, each opponent's margin of victory over the teams played to date, and the like.

In other embodiments, the interparameteric relationships can be customized by the subscriber. Once the recipient creates his or her own personalized formula, the underlying data continues to change over time as events occur (e.g. teams win or lose, players have good or bad days, etc.) Therefore, the fan/customer desires and anticipates receiving updated rankings based on their specific formula.

For example, the subscriber can choose to give more weight to parameters which the subscriber feels are more indicative of a given team's rank to date, to generate a ranking which may have a different order than a ranking done with a standard interparametric relationship used by sports authorities. The subscriber may adjust the weights of the parameters provided in a “master formula” in order to use one known formula rather than another, both of which can be encompassed by the master formula. For instance, the subscriber may choose to give an extra amount of weight to games won which were played at the opposing team's stadium or court. A subscriber alter a master formula by weighting provided parameters according to the subscribers own preference. A subscriber may choose to ignore a variable by weighting the variable with a zero. In one embodiment, the subscriber can arbitrarily include one or more parameters which are not originally encompassed by the master formula. In one embodiment, subscribers have the opportunity to construct their own formula. In yet another embodiment, a subscriber can run rankings according to multiple formulae, get rankings with each which can be compared to each other and/or to the final outcome in order to see which ranking formula produces the result closest to accurate. Such an opportunity can give the sports fan insight into a team's true performance by indicating the relative importance of parameters in determining a ranking which comports with the final season outcome.

Specific examples of updatable ventures are: assessing the “Top-25” football teams; assessing which conference is the best of the SEC, the PAC-10, or the Big-10 conferences; assessing the player most likely to win the Heisman Trophy, Cy Young award, Most Valuable Player, and the like. Other updatable ventures pertain to auto racing or horse racing.

In one embodiment, the recipient accesses results which have been automatically updated. In another embodiment, the recipient can display the results prior to the most current updating, as well as the updated results.

Advertised products and services can include products and services of any type. For non limiting example, products can include food products, fast food products, beverages, airline tickets, trips to Resorts/Casinos, construction tools and services, products of interest to sports fans such as athletic collectables, products of potential interest to sports fans, products for athletes, sports drinks, athletic supplies, gear and clothing, gym memberships, and other products or services.

In yet another embodiment, the subscriber is rewarded for choosing a formula which proves to predict with a given measure of accuracy or better. In one embodiment, the subscriber receives a discount on products advertised with the method of the present invention.

Nonlimiting examples of updatable ventures in the world of entertainment include nominees for and winners of industry awards such as Oscars, Grammys, Emmys, “Top Forty”-type listings of songs; and the like. Parameters can include, for non-limiting example, films, songs, episodes of serially produced programs, and the like.

Non-limiting examples of updatable ventures in the world of finance include the performance of stocks; performances of markets, such as, for example, the housing market; the prices of commodities; the values and yields of financial instruments, such as, for example, government bonds, and the like.

The recipient is preferably exposed to the advertising upon viewing updated results. These updates can be branded with advertising messages which are more likely to be absorbed because they are integrated with requested, personalized content. For example, in a preferred embodiment, the subscribing recipient accesses an online account, and prior to, during or after accessing the account, the recipient is exposed to one or more advertising messages, preferably in a discreet, unobtrusive fashion, such that the experience of retrieving updated results is not interrupted. The advertising message can precede the viewing of the updated results, such as in a transition window which links directly or indirectly to the screen displaying the updated results. The advertising message can be displayed simultaneously with the results, such that the results and the advertising message share the page, for example. In an embodiment, the message is displayed after the accessing of the results, such as in a screen that leads away from the results screen. In yet another embodiment, the recipient is shown the un-updated data upon accessing his account, and must pass through an advertising screen in order to update the results. In yet another embodiment, the advertising message is delivered while the new results are being calculated based upon available updates.

In another embodiment of the present invention, in addition to or instead of an advertising message, a recipient is exposed to an informational message, such as, for example, a health-related message or a weather-related message.

The present inventive advertising method has advantages over other ranking-type methods of advertising.

1. Polls of experts—coaches, writers, or other “experts” vote on who is best.
Polls of experts are one-way communications from the experts to the fan/customer. The communication does not include input from the recipient, and thus no feeling of “ownership” over the ranking. Generally non-updatable.
   2. Computer rankings—computers calculate based upon a formula and data input:
One “correct” formula is used, no recipient interactivity.
   3. Allowing fans to create their own polls directly by listing/selecting things top to bottom.
The lists are static and have limited value over time. Present inventive method can include a formula which produces different outputs over time as the parameter values change. The changing, user-specific output makes the method powerful for integrating advertising and ensuring repeated ad exposure to recipients.

### OTHER EMBODIMENTS AND USES

The method can also be used for any kind of rankings in industries that have fans or customers, including non-limiting examples such as entertainment (e.g. music, TV, movies, stars, personalities, and the like); business (e.g. stocks, companies, and the like); and politics (parties, people, elections, laws, decisions, and the like).
The subscription can be free or a paid service.
Periodic updates could be slow, e.g. once a week, or constantly in near real time.
Advertising may be the same for all recipients, customized to correspond to each recipient's specific formula and/or ranking.
An advertising sponsorship could be something sold to a 3rd party (e.g. ESPN signs Home Depot to sponsor) or it could be done by the offering company (e.g. the Fox Sports you make the ranking).
The method is technology independent and could be accomplished via internet/web/browser, texting/instant messaging, desktop applets/applications, and/or emerging/future technologies.
The data and formula may be straight forward and relatively simple, or may contain meta-formulas for creating complex data to feed the baseline formula.
The ranking could be personalized lists: e.g. #1, #2, #3, #4, or could be used to create a matrix of decisions enabling a competition, e.g. Based on recipient's formula recipient believes: Georgia would beat GT; Texas would beat Oklahoma, USC would beat Stanford, . . . . Based on recipient formula, recipient correctly picked 12 of 19 games and are in 3rd place vs. 55 other players.

### BRIEF DESCRIPTION OF THE DRAWINGS

FIG. 1 shows a view of the major steps, numbered (10) to (50), and interconnections of the method.
The steps are not numbered in a specific order because there are multiple valid paths through this method.

FIG. 2 shows a logical flowchart view of the major steps, numbered (10) to (50), and interconnections of the method.

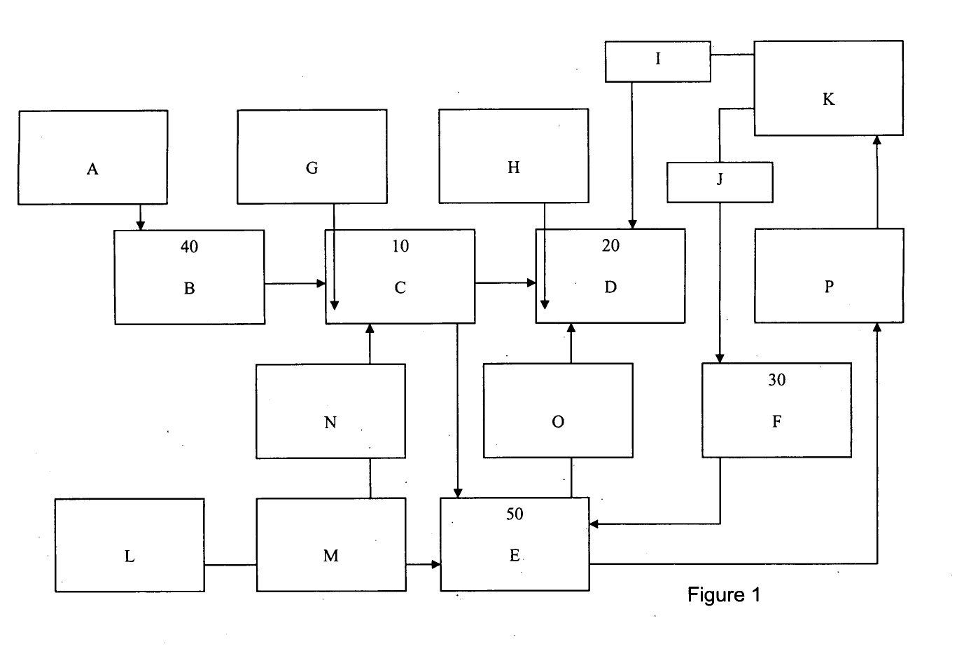

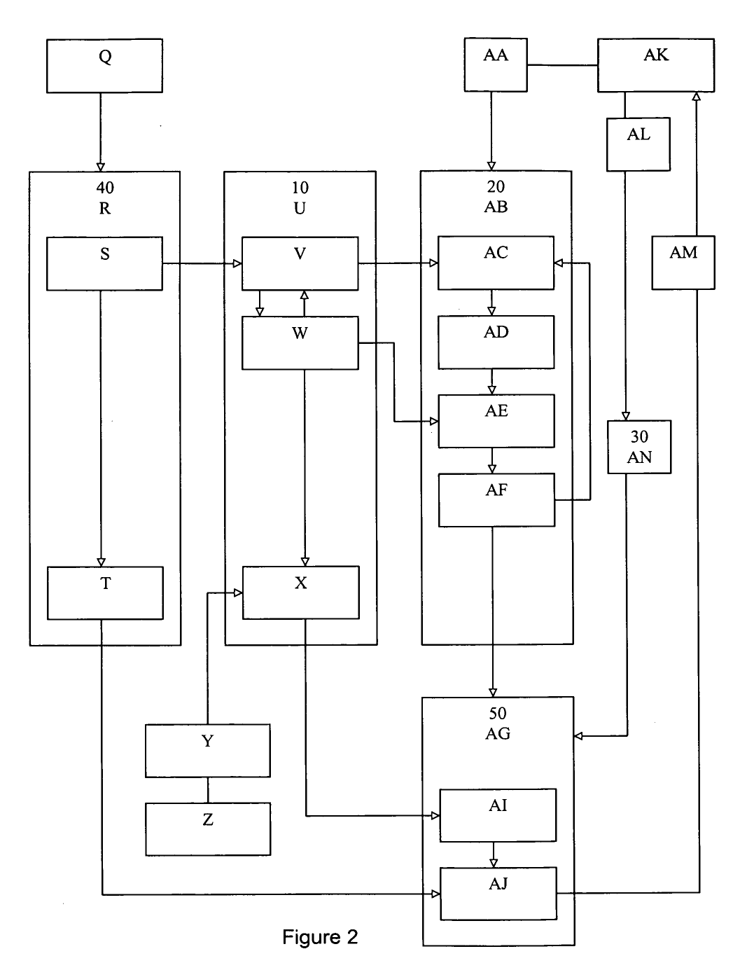

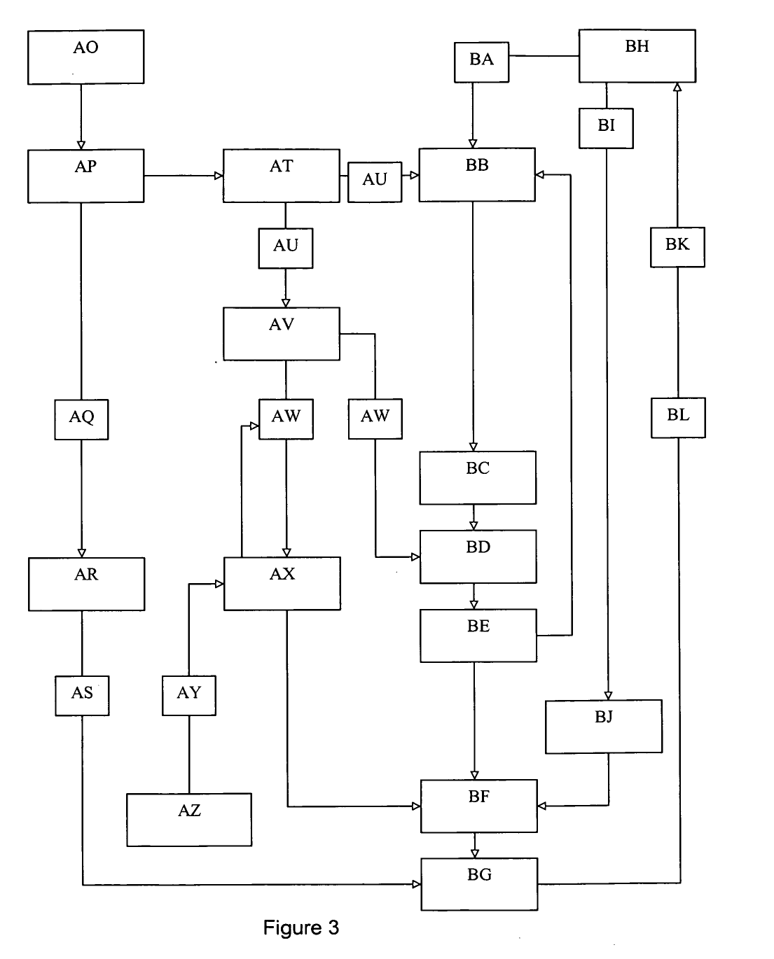

FIG. 3 shows a web-based physical view of this method.
It represents the exact same steps and interconnections as FIG. 2, and expands the illustration by showing one of many possible physical implementations of the method.
This business method is made practical by web technologies which are included in the example but could be superseded by newer technologies in the future. For instance
   Fans define their personalized formulas by logging onto a website via PC-browser, cell phone, blackberry, social-networking site, etc.
   The formulas and data are stored in databases (e.g. SQL, mySQL, etc.)
   The personalized rankings are generated via .NET, .asp, .php, etc.
   The integrated content is sent out via: web, email, text, SMS, gadget, widget, iPhone application, RSS, stand alone connected device, social-networking site, etc.

### EXAMPLE

With respect to FIGS. 1, 2 and 3, non-limiting examples of embodiments of the present invention are discussed in detail below.

### Foundational Formulas and Data are Established (10):

A Baseline Formula Is Developed (12) by analyzing the factors that could make up the ranking for a specific question/poll. For instance, looking at “Who is the #1 Football Team?”, key factors might include:
   Should the ranking reflect who the “best team” is; or who has had the “best season”?
   In judging best season, should the recipient include margin of victory or just wins and losses?
A baseline formula is specified. For instance:

Top_Team_Ranking=A×Best_Season+B×Best_Team

Best_Team=C×Margin_of_Victory+D×Wins_Losses
Based on the baseline formula, Initial Data Is Compiled (14) to enable the formula to calculate correctly.
For instance:

| | | Margin of Victory | |
|---|---|---|---|
| Team | Season Data | Data | Wins/Losses Data |
| Ohio State | 20.96603 | 24.5255 | 66.69259 |
| USC | 20.561 | 18.4272 | 49.86706 |
| Georgia | 13.80889 | 15.4667 | 30.10324 |
| West Virginia | 19.97431 | 33.126 | 36.19933 |

The initial data is used to validate the baseline formula.
Updated Data is Compiled (16) over time as events occur (e.g. teams win or lose) to enable periodically updated, personalized rankings.

### The Recipient Defines Their Formula (20):

Recipient Defines Preferences (22) by weighing each of the variables.
   For instance, in creating their own college football poll, the recipient may select 1/3 best season and 2/3 best team based on margin of victory
Recipient Formula is Generated (24) by combining user preferences with baseline formula.
For instance:

Joe's_Top_Team_Ranking:=33%×Best_Season+67%×Margin_of_Victory

Mark's Top_Team_Ranking:=1%×Best_Season+99%×Wins_Losses
The Data is Applied (26) and an Initial Personalized Ranking is Displayed (28)
For instance:

| Joe's Top 25: | Mark's Top 25 |
|---|---|
| #1 - West Virginia | #1 Ohio State |
| #2 - Ohio State | #2 USC |
| #3 - USC | #3 West Virginia |
| #4 - Georgia | #4 Georgia |

The Recipients adjust their formula weightings until they have finalized their preferred formulae.

Subscription is Requested/Permitted (30). At the beginning, middle, or end of the process for enabling the customer to define their formula, the Recipient signs up, or is signed up, for a subscription to receive periodic updates of their rankings.

Sponsorship is Obtained and Applied (40). An internal or external advertiser is identified and messages developed to be integrated with the personalized rankings.

Ongoing Personalized Rankings are Generated and Communicated with Advertising (50). Periodically, the Recipient's personalized formulas are combined with updated data and advertising to create an integrated, requested piece of content which provides both high value to the Recipient along with advertising messages.

1. A method for advertising a product, said method comprising the following steps:
a) selecting one or more products or services;
b) selecting an updatable venture; wherein said updatable venture comprises two or more interrelated parameters, one or more parametric interrelationships which give, upon operating on at least one of said two or more parameters, one or more resultant values; and wherein at least one of said parameters is updatable to give one or more updated parameters; and wherein upon the operation by said interparameteric relationships on at least one of said updated parameters, one or more updated resultant values are produced;
c) engaging at least one subscriber to said updatable venture;
wherein updated parameter values and/or updated resultant values, and optionally, parameter value and/or resultant values can be accessed by subscribers through a user interface; wherein upon accessing said updates to parameter values and/or updated resultant values, said subscriber is exposed to advertising specific to said one or more products; and
wherein said subscribers are targeted to be from a demographic to which said resultant values are of greater average interest than the average interest of the population at large.

2. A process as in claim 1 wherein said subscribers are targeted such that they are from a demographic to which said product is of greater average interest than the average interest of the population at large.

3. A process as in claim 1 wherein said subscribers enter, via a user interface, indications of choice of parameter and parametric interrelationships.

4. A process as in claim 1 wherein at least one of said parameters and/or parametric interrelationships are adjustable, and the subscriber enters adjustments via a user interface.

5. A process as in claim 1 wherein said parameters and parametric interrelationships are not adjustable by the subscriber.

6. A process as in claims 3, 4, or 5 wherein said updatable venture is a real time sports team league ranking, and said parameters comprise, for at least one team, at least one of the following: identity of team, outcome of games played by team, identity of opponent team in at least one of the games, at least one team played by opponent team, and outcome of at least one opponent game.
